(19) United States
(12) Patent Application Publication
(10) Pub. No.: US 2006/0018684 A1
(43) Pub. Date: Jan. 26, 2006

(54) Image processing apparatus, image processing system, and image processing program storage medium

(75) Inventor: Osamu Shimazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/185,683

(22) Filed: Jul. 21, 2005

(30) Foreign Application Priority Data
Jul. 21, 2004 (JP) 2004-213107

(51) Int. Cl. G03G 15/36; G03G 15/01

(52) U.S. Cl. 399/182; 399/184

(57) ABSTRACT

An image processing apparatus comprises a data set obtaining section that obtains an evaluation image data set in which image data representative of an image is associated with evaluation data representative of an evaluation as to a color of the image represented by the image data, and an image processing section that applies an image processing according to an evaluation represented by the evaluation data of the evaluation image data set to the image data of the evaluation image data set obtained by the data set obtaining section.

### BACKGROUND OF THE INVENTION

1. Field of the Invention

The present invention relates to an image processing apparatus for applying image processing to image data, an image processing system, and an image processing program storage medium storing an image processing program, when executed in a computer, which causes the computer to operate as the image processing apparatus.

2. Description of the Related Art

Hitherto, in a field of printing, it is widely performed that a printed matter is created through an image taking step of obtaining a photographic image through photography of a subject, an editing step of editing an image of the printed matter using the photographic image, and a printing step of printing the edited image. Recently, a digital camera is widely used in the image taking step, and as a digitalization of the photographic image obtained in the image taking step is advanced, processing of the editing step and the printing step is also varied.

FIG. 1 is a work flowchart useful for understanding a series of printing processing wherein a silver halide camera for recording a photographic image on a film is applied in the image taking step.

In the image taking step, the silver halide camera is used to take a photograph of a subject, and a photographic image is recorded on a film 11. The film 11 is transferred from the image taking step to the editing step.

In the editing step, first, a scanner and the like roughly reads the photographic image recorded on the film 11 so as to generate low resolution data through the color separation into R (red), G (green), and B (blue), for instance (step S111).

An editor, who is an operator in the editing step, uses a personal computer and the like to edit an image of the printed matter including a low resolution of image represented by a RGB type of low resolution data that is obtained in the step S111 (step S112). As a data format, which is used when an editor edits pages, there is generally used a format in which pages are described in a page description language such as PS (PostScript: registered trademark) and PDF (Portable Document Format). And thus, hereinafter, image data representative of an image (page) of the printed matter after the edition is referred to as page data. In the page editing step of the step S112, an RGB format of page image 12 included in the page data is printed out by a printer and the like to confirm designs of the page using the RGB format of page image 12. The page data, which is subjected to confirmation of the design, is transferred to the printing step together with the film 11.

In the printing step, first, a scanner and the like is used to read the photographic image recorded on the film 11 on a high resolution basis, and simultaneously, in order that a printing machine may express the whole colors through superposition of C (cyan), M (magenta), Y (yellow) and K (black) on one another, the image data thus read is converted into a CMYK format of high resolution data, which is suitable for the printing machine (step S113). At that time, a printing operator in the printing step performs a fine control for various parameters as to a tone curve, sharpness and the like so that colors of a CMYK image 13 represented by the CMYK format of high resolution data may be close to colors of the photographic image of the film 11 in impression as much as possible, and performs a color conversion processing using the various parameters.

The CMYK format of high resolution data thus generated is replaced by a RGB format of low resolution data of the page data transmitted from the editing step, so that a CMYK format of high resolution page data is generated (step S114). Also in the step S114, a CMYK page image 14 represented by a CMYK format of page data is printed out so that a printing operator confirms designs and colors of the final page using the CMYK page image 14.

The finally confirmed CMYK format of page data is transmitted to a printing machine to print a printed image 15 (step S115).

In a case where a photographic image is recorded on a film, the printed image 15 is created in the manner as mentioned above. A series of printing processing shown in FIG. 1 is conventionally performed. Accordingly, also in the process, which needs a sophisticated technique, for example, control of various sorts of parameters in the step S113, it is possible to utilize know-how accumulated. However, according to the work flowchart in FIG. 1, all of the image taking step, the editing step and the printing step needs the film 11 on which a photographic image is recorded. In this case, in the event that the respective steps are carried out in mutually different area, it would take a lot of time for the delivery of the film 11, and there would be raised a possibility that the film 11 is lost. This involves a problem that the printed matter cannot be created.

Next, there will be explained a series of printing processing when the photographic image is digitized.

FIG. 2 is a work flowchart useful for understanding a series of printing processing wherein a digital camera is applied in the image taking step.

In the image taking step, photographic image data, which is obtained when the digital camera is used to photography a subject, is recorded on a compact sized recording medium and the like, and is transferred to the editing step.

In the editing step, an editor performs a fine control for various parameters (for example, the tone curve) as to a color correction so that colors of an RGB image 21 represented by the photographic image data may be preferable colors in impression, and color correction processing is applied to the photographic image data (step S121). The photographic image data after the color correction is saved in DB for the sake of reuse.

Next, the editor edits a page using the photographic image data after the color correction (step S122). Also in the step S122, an RGB page image 22 represented by the generated page data is printed out, and the editor confirms designs and colors of the page.

The page data after confirmation of the designs and colors is transferred to a printing step.

In the printing process, first, an RGB image 23 represented by the photographic image data after the color correction of the page data transmitted from the editing step is printed out. In a similar fashion to that of the step S113 in FIG. 1, a printing operator performs a fine control for various parameters as to a color conversion, and an RGB format of photographic image data is converted into a CMYK format of photographic image data (step S123). At that time, the printing operator controls various parameters so that colors of a CMYK image 24 represented by the CMYK format of photographic image data may be close to colors of the RGB image 23.

Further, in the printing process, the RGB format of photographic image data of the page data transmitted from the editing step is replaced by a CMYK format of photographic image data, so that a CMYK format of page data is generated. The editor confirms designs and colors of the final page using CMYK page image 25 represented by the CMYK format of page data (step S124).

The finally confirmed CMYK format of page data is transmitted to a printing machine to print out a printed image 26 (step S125).

In the manner as mentioned above, a digital photographic image is obtained in the image taking step. This feature makes it possible to reuse the photographic image saved in the DB in the editing step (cf. for example, Japanese Patent Laid Open Gazette TokuKai Hei. 9-90599), and also to readily copy the photographic image. Accordingly, it is possible to resolve such an inconvenience that the printed matter cannot be created because of missing of a film. Further, even if the respective steps are carried out in mutually different area, it is possible to transmit the photographic image through communication networks and the like.

However, the work for the color correction by an editor in the step S121 in FIG. 2 is only performed when a digital camera is used in the image taking step, and thus the know-how is not sufficiently accumulated. Accordingly, there is a need for an editor to perform a color control through trial and error so that colors of the RGB image 21 become colors be nice to look at. This work takes a great deal of time, and it often happen that no intended colors may be obtained. As a result, in the step S123 of the printing step, a printing operator would perform a color control taking as a color sample the RGB image 23 involved in no accumulation of know-how such as the film 11 that is used for the conventional color regulation, under the uncertain condition as to whether it has editor's intended colors. This work would take great deal of time and cost. Further, even if such a color regulation is performed so that the colors of the CMYK image 24 are close to the colors of the RGB image 23, it would happen that colors of a printed matter 26, which is the final creation, don't match the color image of the editor's intended printed matter, since the colors of the RGB image 23 are uncertain per se.

In order to avoid such a trouble, there is proposed a matter that when image data is sent from the editing step to the printing step, a label, on which various sorts of information as to color correction processing, such as a profile name that is used at the time of the color correction in the editing step, is applied to a recording medium such as a CD-ROM on which image data after the color correction is recorded, so that an editor's requirement is surely conveyed to the subsequent printing step (cf. “WORKING GUIDEBOOK OF RGB IMAGE FOR PRINTING ENTRY” page 7, A SOCIETY FOR THE STUDY OF RGB DIGITAL IMAGE STANDARDIZATION). When a printing operator in the printing step controls various sorts of parameters for the color correction in accordance with contents described on the label, it makes it possible to perform the color regulation processing in which an editor's requirement is reflected.

However, according to the technology proposed by the above-cited reference “WORKING GUIDEBOOK OF RGB IMAGE FOR PRINTING ENTRY” page 7, A SOCIETY FOR THE STUDY OF RGB DIGITAL IMAGE STANDARDIZATION, it would happen that the label applied to the recording medium comes off during conveyance, and in the event that the photographic image is transmitted through a communication network, it is impossible to surely convey an editor's requirement to the printing step. Further, also in the technology proposed by the above-cited reference “WORKING GUIDEBOOK OF RGB IMAGE FOR PRINTING ENTRY” page 7, A SOCIETY FOR THE STUDY OF RGB DIGITAL IMAGE STANDARDIZATION, there is needed for a printing operator a technique skilled in setting parameters for the color regulation according to the editor's requirement, and thus it is wished to develop an image processing apparatus capable of easily obtaining an image in which an editor's requirement is reflected.

### SUMMARY OF THE INVENTION

In view of the foregoing, it is an object of the present invention to provide an image processing apparatus capable of surely conveying information for generating an image of a preferable color to the subsequent step, and also capable of easily obtaining an image in which a requirement in the preceding step is reflected, an image processing system, and an image processing program storage medium storing an image processing program, when executed in a computer, which causes the computer to operate as the image processing apparatus.

To achieve the above-mentioned objects, the present invention provides an image processing apparatus comprising:

a data set obtaining section that obtains an evaluation image data set in which image data representative of an image is associated with evaluation data representative of an evaluation as to a color of the image represented by the image data; and

an image processing section that applies an image processing according to an evaluation represented by the evaluation data of the evaluation image data set to the image data of the evaluation image data set obtained by the data set obtaining section.

According to the image processing apparatus of the present invention as mentioned above, it is possible to surely convey editor's wishes to the printing step, and thereby performing an image processing reflecting the editor's wishes, without need of skilled art.

In the image processing apparatus according to the present invention as mentioned above, it is preferable that the evaluation image data set is one in which the image data representative of the image is associated with evaluation data representative of an evaluation as to whether a color of the image represented by the image data is a color close to a desired color, and

the image processing section that omits a predetermined image processing for bringing the color of the image close to the desired color or applies the predetermined image processing to the image data of the evaluation image data set in accordance with situations whether the evaluation represented by the evaluation data of the evaluation image data set is concerned with an evaluation that the color of the image is close to the desired color.

For example, in a case where it is confirmed in the editing step that a color of an image represented by the image data is a preferable color that is nice to look at, an application of the evaluation data representative of an evaluation that it is a color close to a desired color makes it possible to omit the image processing for controlling the color of the image in the printing step.

In the image processing apparatus according to the present invention as mentioned above, it is preferable that the evaluation image data set is one in which the image data representative of the image is associated with evaluation data representative of a difference between the color of the image represented by the image data and a desired color, and

the image processing section that applies image processing for correcting a color of an image to the image data of the evaluation image data set in accordance with a difference represented by the evaluation data of the evaluation image data set.

An important inventive feature of the present invention resides in the point that the image processing for correcting a color of an image is automatically performed in accordance with a difference between the color of the image represented by the image data and a desired color. This feature makes it possible to readily perform the image processing for correcting the color of the image represented by the image data to the desired color, without need of skilled art.

To achieve the above-mentioned objects, the present invention provides an image processing system comprising:

an image obtaining section that obtains image data representative of an image;

an evaluation receiving section that receives an input of an evaluation as to a color of the image represented by the image data obtained by the image obtaining section;

a data set generation section that generates an evaluation image data set in such a way that the image data obtained by the image obtaining section is associated with evaluation data representative of the evaluation received by the evaluation receiving section;

a data set obtaining section that obtains the evaluation image data set; and

an image processing section that applies an image processing according to an evaluation represented by the evaluation data of the evaluation image data set to the image data of the evaluation image data set obtained by the data set obtaining section.

According to the image processing system of the present invention as mentioned above, it is possible to surely convey an evaluation as to the color of the image represented by the image data to the subsequent step, so that the image processing is readily performed in accordance with the evaluation.

To achieve the above-mentioned objects, the present invention provides an image processing program storage medium storing an image processing program which causes a computer to operate as an image processing apparatus, when the data generating program is executed in the computer, the image processing apparatus comprising:

a data set obtaining section that obtains an evaluation image data set in which image data representative of an image is associated with evaluation data representative of an evaluation as to a color of the image represented by the image data; and

an image processing section that applies an image processing according to an evaluation represented by the evaluation data of the evaluation image data set to the image data of the evaluation image data set obtained by the data set obtaining section.

According to the image processing program storage medium storing an image processing program, it is possible to cause the computer to operate as the image processing apparatus, when the image processing program is executed in the computer.

With respect to the structural elements such as the image obtaining section constituting the image processing program related to the present invention, it is acceptable that function of one structural element is implemented by one program part, function of one structural element is implemented by a plurality of program parts, or alternatively functions of a plurality structural elements are implemented by one program part. Further, it is acceptable that those structural elements are executed by oneself or by instruction to another program or program parts incorporated into a computer.

### BRIEF DESCRIPTION OF THE DRAWINGS

FIG. 1 is a work flowchart useful for understanding a series of printing processing wherein a silver halide camera for recording a photographic image on a film is applied in the image taking step.

FIG. 2 is a work flowchart useful for understanding a series of printing processing wherein a digital camera is applied in the image taking step.

FIG. 3 is an overall structural view of a printing system to which an embodiment of an image processing system of the present invention is applied.

FIG. 4 is a perspective view of a personal computer.

FIG. 5 is a hardware structural view of the personal computer.

FIG. 6(A) is a conceptual view of a CD-ROM storing a data generating program as an embodiment of the present invention.

FIG. 6(B) is a conceptual view of a CD-ROM storing an image processing program as an embodiment of the present invention.

FIG. 7 is a functional block diagram of an editing apparatus and a color conversion apparatus.

FIG. 8 is a flowchart useful for understanding a series of processing from a generation of image data in the editing step to a generation of RGB page data into which evaluation incorporation data is incorporated.

FIG. 9 is a flowchart useful for understanding a series of processing from a generation of the RGB page data in the printing step to performing a printing.

FIG. 10 is a view showing an example of a screen for an evaluation entry.

FIG. 11 is a view showing an example of a screen in which an evaluation is displayed.

### DETAILED DESCRIPTION OF PREFERRED EMBODIMENTS

Embodiments of the present invention will be described with reference to the accompanying drawings.

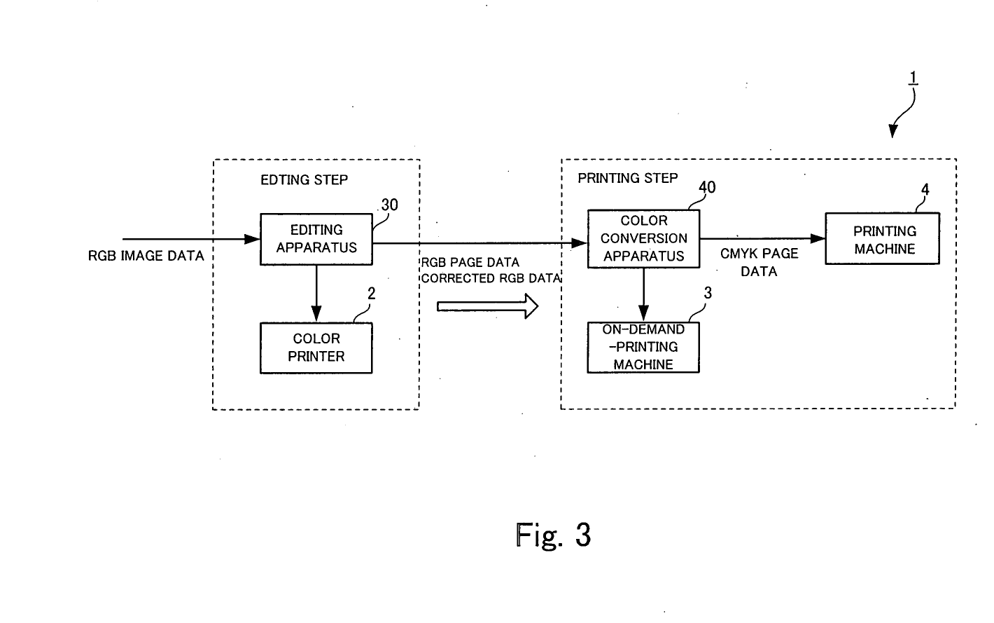

FIG. 3 is an overall structural view of a printing system to which an embodiment of an image processing system of the present invention is applied.

A printing system 1 creates a printed matter through an editing step and a printing step. The printing system 1 comprises an editing apparatus 30, a color printer 2, a color conversion apparatus 40, an on-demand-printing machine 3, and a printing machine 4. According to the present embodiment, the editing apparatus 30 and the color printer 2 can deal with only the RGB format of image data, the printing machine 4 can deal with only the CMYK format of image data, and the color conversion apparatus 40 and the on-demand-printing machine 3 can deal with both the RGB format of image data and the CMYK format of image data. And the editing step and the printing step are installed at mutually different areas. The editing apparatus 30 of the editing step is connected via a communication network with the color conversion apparatus 40 of the printing step.

The editing apparatus 30 of the editing step receives the RGB format of image data, which is obtained through photography of the subject by a digital camera. The editing apparatus 30 first performs the color correction processing for correcting a color of an image represented by the RGB format of image data to a color be nice to look at, using a standard color correction profile and the like prepared beforehand. Incidentally, the color correction processing is carried out in accordance with an editor's instruction, and thus it may happen that the color correction processing is omitted. Further, the editing apparatus 30 creates RGB page data incorporating RGB image data, wherein an editor edits a page including an image represented by the RGB image data. The image represented by the RGB page data and the image represented by the RGB image data are printed out by the color printer 2 so as to be confirmed in designs and colors. The RGB page data and the RGB image data, which are created in the editing step, are transmitted via the communication network and the like to the printing step.

In the printing step, the color conversion apparatus 40 performs the color conversion of the RGB image data of the RGB page data to the CMYK format of image data, and CMYK page data after the color conversion is transmitted to the printing machine 4 so that the printing machine is printed. In the printing step, a color conversion processing is performed in accordance with an editor's requirement. Accordingly, there is a need to surely convey to the printing step accuracy of the color correction processing to be carried out in the editing step and reliability of the color of the image represented by the RGB image data.

The printing system 1 is basically constructed in the manner as mentioned above.

An aspect of the embodiment of the present invention as to the printing system 1 shown in FIG. 3 resides in a series of processing in which an evaluation of colors of the image represented by the RGB image data obtained in the editing step is surely transmitted to the printing step, and in the printing step, an image processing is performed in accordance with the evaluation. Hereinafter, there will be explained the editing apparatus 30 and the color conversion apparatus 40, which constitute the printing system 1. Incidentally, the editing apparatus 30 and the color conversion apparatus 40 are constituted of the similar personal computers, respectively. Accordingly, with respect to the appearance and the hardware structure, there will be explained the editing apparatus 30 and the color conversion apparatus 40 together applying the same reference numbers.

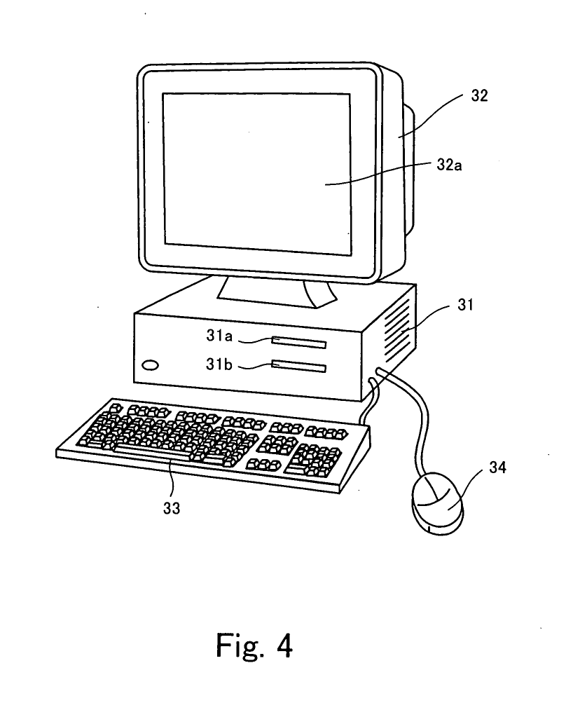

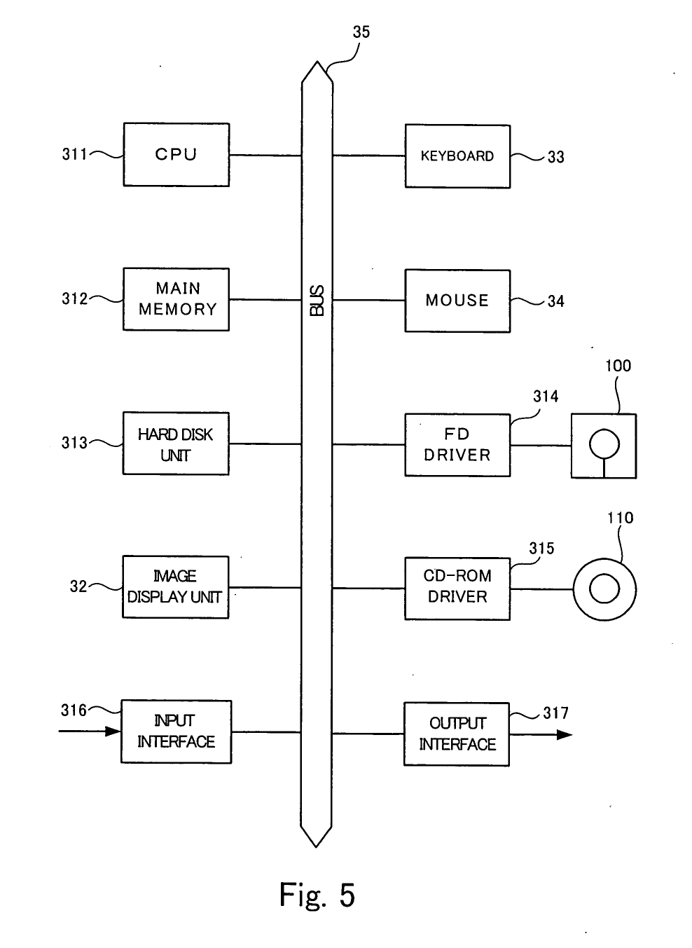

FIG. 4 is a perspective view of a personal computer of the editing apparatus 30 and the color conversion apparatus 40. FIG. 5 is a hardware structural view of the personal computer.

The personal computer of the editing apparatus 30 and the color conversion apparatus 40 comprises, on an external appearance, a main frame unit 31, an image display unit 32 for displaying an image on a display screen 32a in accordance with an instruction from the main frame unit 31, a keyboard 33 for inputting various sorts of information to the main frame unit 31 in accordance with a key operation, and a mouse 34 for inputting an instruction according to, for example, an icon and the like, through designation of an optional position on the display screen 32a, the icon and the like being displayed on the position on the display screen 32a. The main frame unit 31 has a flexible disk mounting slot 31a for mounting a flexible disk (FD), and a CD-ROM mounting slot 31b for mounting a CD-ROM.

The main frame unit 31 comprises, as shown in FIG. 5, a CPU 311 for executing a various types of program, a main memory 312 in which a program stored in a hard disk unit 313 is read out and developed for execution by the CPU 311, the hard disk unit 313 for saving various types of programs and data, a flexible disk drive 314 for accessing a flexible disk (FD) 100 mounted thereon, a CD-ROM drive 315 for accessing a CD-ROM 110 mounted thereon, an input interface 316 that receives image data from the exterior, and an output interface 317 that transmits image data to the exterior. These various types of elements are connected via a bus 35 to the image display unit 32, the keyboard 33 and the mouse 34.

The CD-ROM 110 stores therein a data generating program. The CD-ROM 110 is mounted on the CD-ROM drive 315 so that the data generating program, which is stored in the CD-ROM 110, is up-loaded on the editing apparatus 30 and is stored in the hard disk unit 313.

Further, a CD-ROM 111 (not illustrated in FIG. 5) stores therein an image processing program. The CD-ROM 111 is mounted on the CD-ROM drive 315 of the color conversion apparatus 40 shown in FIG. 3 so that the image processing program, which is stored in the CD-ROM 111, is up-loaded on the color conversion apparatus 40 and is stored in the hard disk unit 313.

Thus, the color conversion apparatus 40 serves as an imager processing apparatus according to an embodiment of the present invention. And a combination of the editing apparatus 30 and the color conversion apparatus 40 serves as an example of the image processing system of the present invention.

Next, there will be explained the data generating program to be executed in the editing apparatus 30 and the image processing program to be executed in the color conversion apparatus 40.

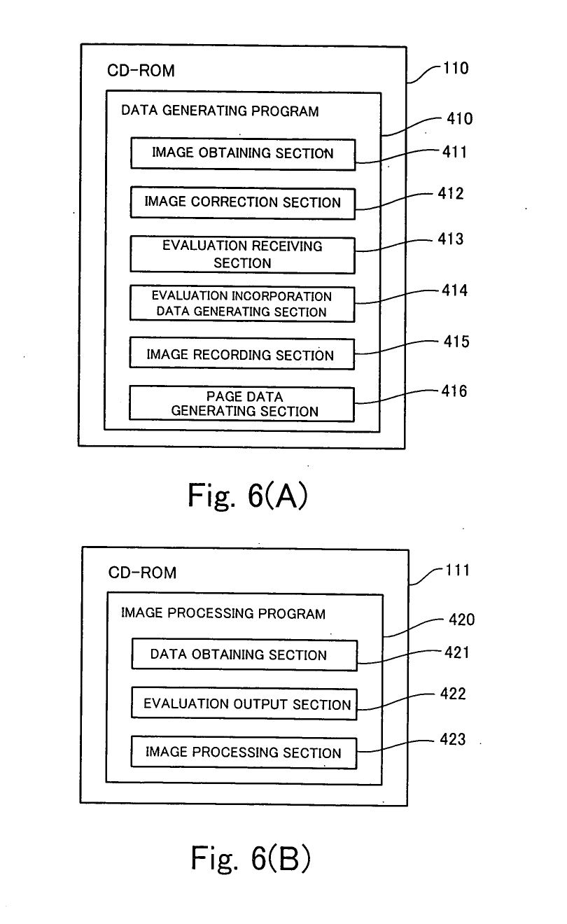

FIG. 6(A) is a conceptual view of the CD-ROM 110 storing a data generating program. FIG. 6(B) is a conceptual view of the CD-ROM 111 storing an image processing program.

A data generating program 410 shown in FIG. 6(A) is executed in the editing apparatus 30 shown in FIG. 3. The data generating program 410 comprises an image obtaining section 411, a color correction section 412, an evaluation receiving section 413, an evaluation incorporation data generating section 414, an image recording section 415, and a page data generating section 416.

An image processing program 420 shown in FIG. 6(B) is executed in the color conversion apparatus 40 shown in FIG. 3. The image processing program 420 comprises a data obtaining section 421, an evaluation output section 422, an image processing section 423.

There will be described later details of the data generating program 410 and the image processing program 420.

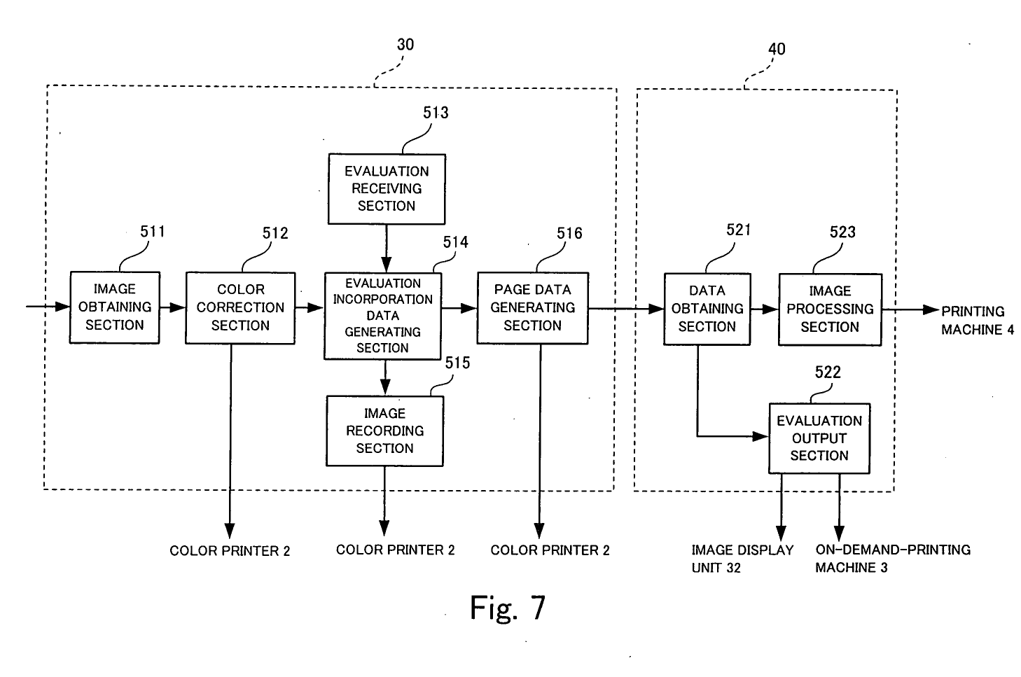

FIG. 7 is a functional block diagram of the editing apparatus 30 and the color conversion apparatus 40.

The editing apparatus 30 comprises an image obtaining section 511, a color correction section 512, an evaluation receiving section 513, an evaluation incorporation data generating section 514, an image recording section 515, and a page data generating section 516. The image obtaining section 511, the color correction section 512, the evaluation receiving section 513, the evaluation incorporation data generating section 514, the image recording section 515, and the page data generating section 516 are constructed on a personal computer by the image obtaining section 411, the color correction section 412, the evaluation receiving section 413, the evaluation incorporation data generating section 414, the image recording section 415, and the page data generating section 416, respectively, which constitute the data generating program 410 shown in FIG. 6(A). Thus, the elements of the editing apparatus 30 shown in FIG. 7 correspond to the elements of the data generating program 410 shown in FIG. 6(A), respectively. It is noted, however, that while the elements of the editing apparatus 30 shown in FIG. 7 are constructed by combinations of the hardware of the personal computer shown in FIG. 4 with an OS and an application program, which are executed in the personal computer, the elements of the data generating program 410 shown in FIG. 6(A) are constructed by only the application program.

The color conversion apparatus 40 shown in FIG. 7 comprises a data obtaining section 521, an evaluation output section 522, and an image processing section 523. The data obtaining section 521, the evaluation output section 522, and the image processing section 523 are constructed on a personal computer by the data obtaining section 421, the evaluation output section 422, and the image processing section 423, respectively, which constitute the image processing program 420 shown in FIG. 6(B). Thus, the elements of the color conversion apparatus 40 shown in FIG. 7 correspond to the elements of the image processing program 420 shown in FIG. 6(B), respectively. It is noted, however, that while the elements of the color conversion apparatus 40 shown in FIG. 7 are constructed by combinations of the hardware of the personal computer shown in FIG. 4 with an OS and an application program, which are executed in the personal computer, the elements of the evaluation output program 420 shown in FIG. 6(B) are constructed by only the application program.

Hereinafter, there will be explained the respective elements of the editing apparatus 30 and the respective elements of the color conversion apparatus 40 shown in FIG. 7, and in addition the respective elements of the data generating program 410 shown in FIG. 6(A) and the respective elements of the image processing program 420 shown in FIG. 6(B).

The image obtaining section 511 of the editing apparatus 30 shown in FIG. 7 obtains RGB format of photographic image data, which is obtained through photography of the subject by a digital camera, in the image taking step that is the pre-step of the editing step.

The color correction section 512 applies to the RGB image data obtained by the image obtaining section 511 the color correction processing according to a color correcting parameter designated by an editor, and the standard color correction processing using a previously prepared color correction profile so as to generate corrected RGB data. The color correction processing of the color correction section 512 is carried out in accordance with an editor's instruction, and it may happen that the color correction processing is omitted. Hereinafter, for the sake of convenience of the explanation, the RGB image data omitted in the color correction processing is also referred to as the corrected RGB data.

The evaluation receiving section 513 receives an input of an evaluation of a color of the RGB correction image represented by the corrected RGB data and generates evaluation data representative of the evaluation of the color. The evaluation receiving section 513 corresponds to an example of the evaluation receiving section referred to in the present invention.

The evaluation incorporation data generating section 514 incorporates evaluation data into the corrected RGB data to generate evaluation incorporation data. The evaluation incorporation data generating section 514 corresponds to an example of the data set generating section referred to in the present invention.

The image recording section 515 records the corrected RGB data and the evaluation incorporation data onto the hard disk unit 313 and the CD-ROM .110 shown in FIG. 5.

The page data generating section 516 generates RGB page data incorporating thereinto the evaluation incorporation data, which is representative of the page that arranges RGB correcting image represented by the corrected RGB data included in the evaluation incorporation data.

The data obtaining section 521 of the color conversion apparatus 40 obtains the RGB page data incorporating thereinto the evaluation incorporation data, which is generated in the page data generating section 516 of the editing apparatus 30. The data obtaining section 521 corresponds to an example of the data set obtaining section referred to in the present invention.

The evaluation output section 522 transmits the evaluation data of the evaluation incorporation data incorporated into the RGB page data to the image display unit 32 and the on-demand-printing machine 3, and causes the image display unit 32 and the on-demand-printing machine 3 to output evaluations represented by the evaluation data.

The image processing section 523 applies an image processing according to the evaluation represented by the evaluation data of the evaluation incorporation data to the corrected RGB data of the evaluation incorporation data incorporated into the RGB page data, and converts the corrected RGB data of the evaluation incorporation data incorporated into the RGB page data to a CMYK format of image data and generates a CMYK format of CMYK page data. The image processing section 523 corresponds to an example of the image processing section referred to in the present invention. The thus generated CMYK page data is transmitted to the printing machine 4 of FIG. 3 so as to generate a page represented by the CMYK page data.

The editing apparatus 30 and the color conversion apparatus 40 are basically constructed in the manner as mentioned above.

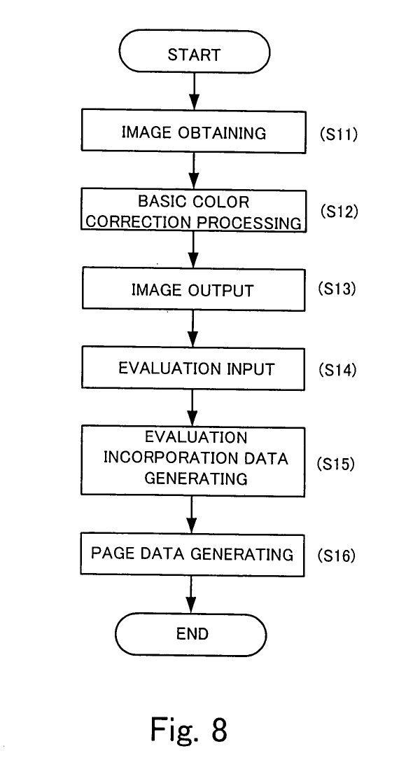

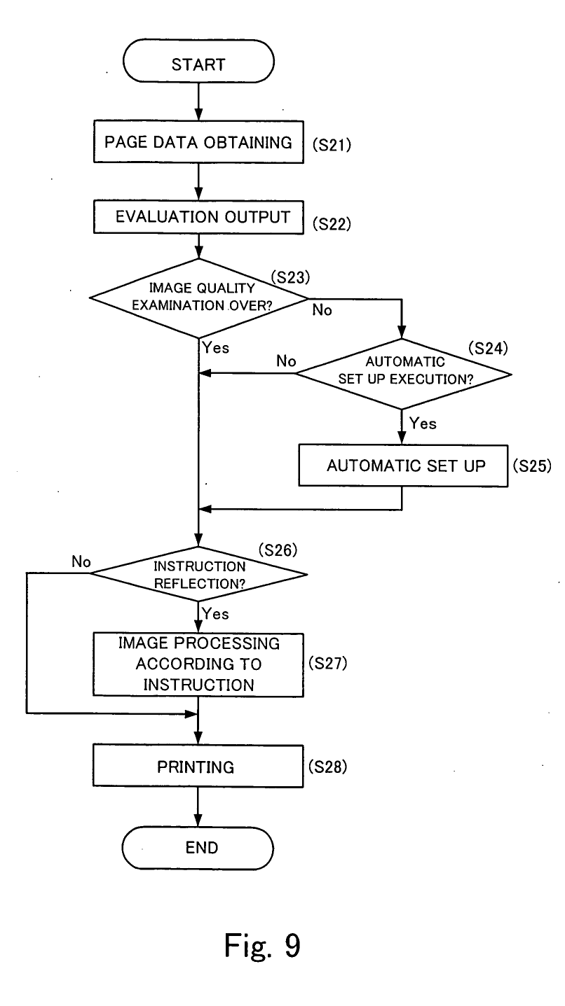

FIG. 8 is a flowchart useful for understanding a series of processing from a generation of image data in the editing step to a generation of RGB page data into which evaluation incorporation data is incorporated. FIG. 9 is a flowchart useful for understanding a series of processing from a generation of the RGB page data in the printing step to performing a printing.

First, there will be explained a series of processing to be carried out in the editing apparatus 30 in accordance with the flowchart of FIG. 8.

The image obtaining section 511 of the editing apparatus 30 obtains the RGB format of image data obtained in the image taking step (step S11 in FIG. 8). The obtained RGB image data is fed to the color correction section 512.

The color correction section 512 applies the color correction processing to the RGB image data obtained in the image obtaining section 511 (step S12 in FIG. 8). The color correction processing is carried out in accordance with an editor's instruction, and thus it may happen that the color correction processing is omitted. According to the present embodiment, a standard color correction profile, which is adopted on a common basis between the editor and the printing operator, is used to apply the standard color correction processing that a color of an image, which is represented by the RGB image data, is nice to look at. The corrected RGB data, which is subjected to the color correction, is fed to the evaluation incorporation data generating section 514 and the color printer 2 of FIG. 3 as well, so that the color printer 2 prints out the RGB correction image represented by the corrected RGB data (step S13 in FIG. 8).

The editor visually confirms the RGB correction image thus printed out and enters the evaluation for a color of the RGB correction image to an image of a color of the printed matter of interest in accordance with a prepared evaluation entry screen (step S14 in FIG. 8).

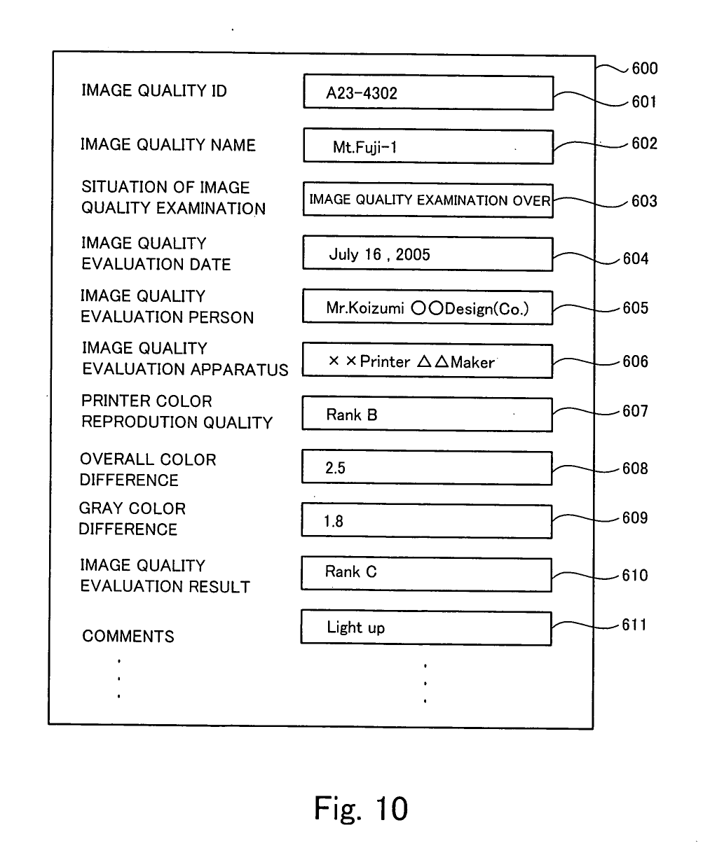

FIG. 10 is a view showing an example of a screen for an evaluation entry.

An evaluation entry screen 600 comprises an image ID entry section 601, an image name entry section 602, an image quality examination situation entry section 603, an image quality evaluation date entry section 604, an image quality evaluation person entry section 605, an image quality evaluation apparatus entry section 606, a printer color reproduction quality entry section 607, an overall color difference entry section 608, a gray color difference entry section 609, an image quality evaluation result entry section 610, and a comment entry section 611.

The image ID entry section 601 adapts to enter an image ID to identify an RGB correction image. The image name entry section 602 adapts to enter an image name of an RGB correction image.

The image quality examination situation entry section 603 adapts to enter information as to whether an editor confirm a color of the RGB correction image. According to the present embodiment, in the event that an editor confirms that the color of the RGB correction image is nice to look at and there is no need to apply to the corrected RGB data a color correction processing for correcting the color of the RGB correction image, an “image quality examination over” is entered; in the event that the editor confirms that the color of the RGB correction image is different from the intended color and there is a need to apply to the corrected RGB data the color correction processing for correcting the color of the RGB correction image, an “image quality examination pending” is entered; and in the event that the color correction processing is not applied in the step S12 and the image, which is obtained in the image taking step, is adopted, a “photographic original” is entered.

The image quality evaluation date entry section 604 adapts to enter date of the evaluation. The image quality evaluation person entry section 605 adapts to enter person's name of the editor who evaluates. The image quality evaluation apparatus entry section 606 adapts to enter a trade name of the color printer 2 shown in FIG. 3, which prints out the RGB correction image.

The color printer 2 previously prints out a color patch composed of a plurality of colors of patches mutually different colors, and the editor measures chromaticity of the plurality of colors of patches. The printer color reproduction quality entry section 607 adapts to enter a rank in which an average color difference between the measured chromaticity values and the target chromaticity value is placed in a category. The overall color difference entry section 608 adapts to enter the average color difference. The gray color difference entry section 609 adapts to enter an average color difference in a gray that is particularly important color in printing.

The image quality evaluation result entry section 610 adapts to enter a rank in which color reproduction quality, such as brightness of the primary color and the secondary color, a gray balance, and reproduction quality of skin color, in the RGB correction image, and reproduction quality of color tone, such as overall luminous intensity, highlight reproduction quality, shadow reproduction quality, and tone jump, are placed in a category.

The comment entry section 611 adapts to enter editor's comments, such as “light up”, “modulate”, “remove color fog”, “remove color muddiness”, be soft”, and “scatter catch light (lights of glass and metal).

In addition to the above-mentioned items, there are entered, for example, information such as photographic date as to the photography in the image taking step, lighting environment, a cameraman, a camera, and exposure conditions, a format of a film saving the RGB correction image, a data size, an existence of data compression, and an image correction instruction.

An evaluation of the color entered by the editor is received by the evaluation receiving section 513 in FIG. 7. The evaluation receiving section 513 generates evaluation data representative of evaluation of the color, and transmits the generated evaluation data to the evaluation incorporation data generating section 514.

The evaluation incorporation data generating section 514 incorporates evaluation data transmitted from the evaluation receiving section 513 into the corrected RGB data transmitted from the color correction section 512 to generate evaluation incorporation data (step S15 in FIG. 8). The thus generated evaluation incorporation data and the corrected RGB data are fed to the image recording section 515 and the page data generating section 516.

With respect to a method of incorporating the evaluation data into the RGB image data, there are considered some ways. For example, in a case where the image data is concerned with the TIFF image, it is considered that the evaluation data is incorporated into a private tag of the TIFF image data. Further, it is considered that the ICC profile is appended to the TIFF image and the evaluation data is incorporated into a private tag. In case of the PDF file, it is acceptable that the evaluation data is incorporated into a comment section of the image data.

Further, it is acceptable that there is provided an additional file in which the image data is associated with the evaluation data, without providing the same data file through incorporating thereinto the evaluation data.

The image recording section 515 records the evaluation incorporation data and the corrected RGB data on the hard disk unit 313 in FIG. 5. The evaluation incorporation data and the corrected RGB data are used at the time of the page editing which will be explained next, and also re-used at the time of the editing work repeatedly.

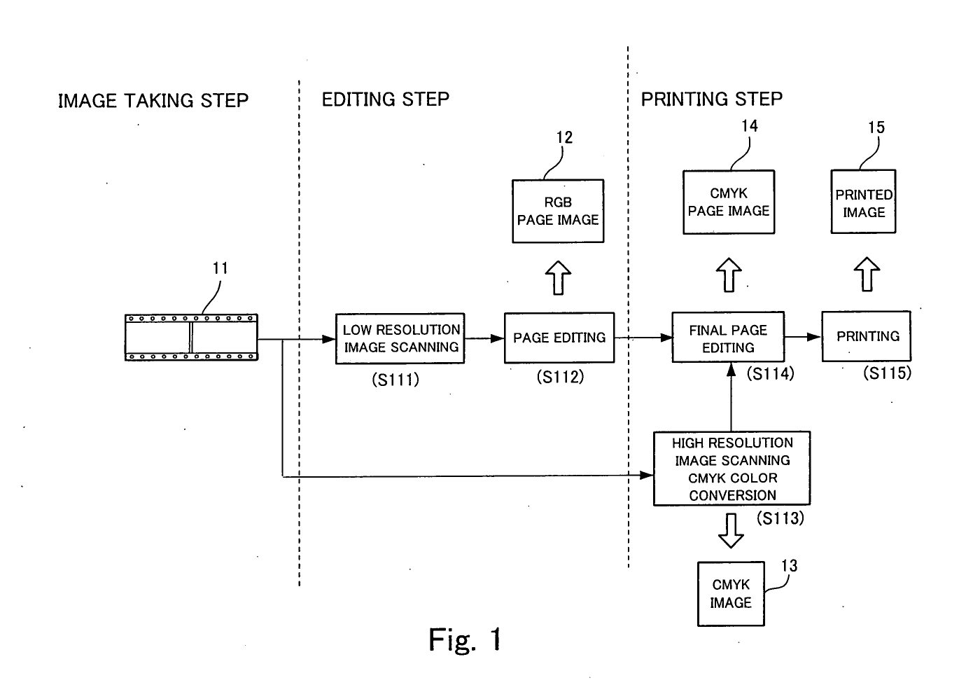

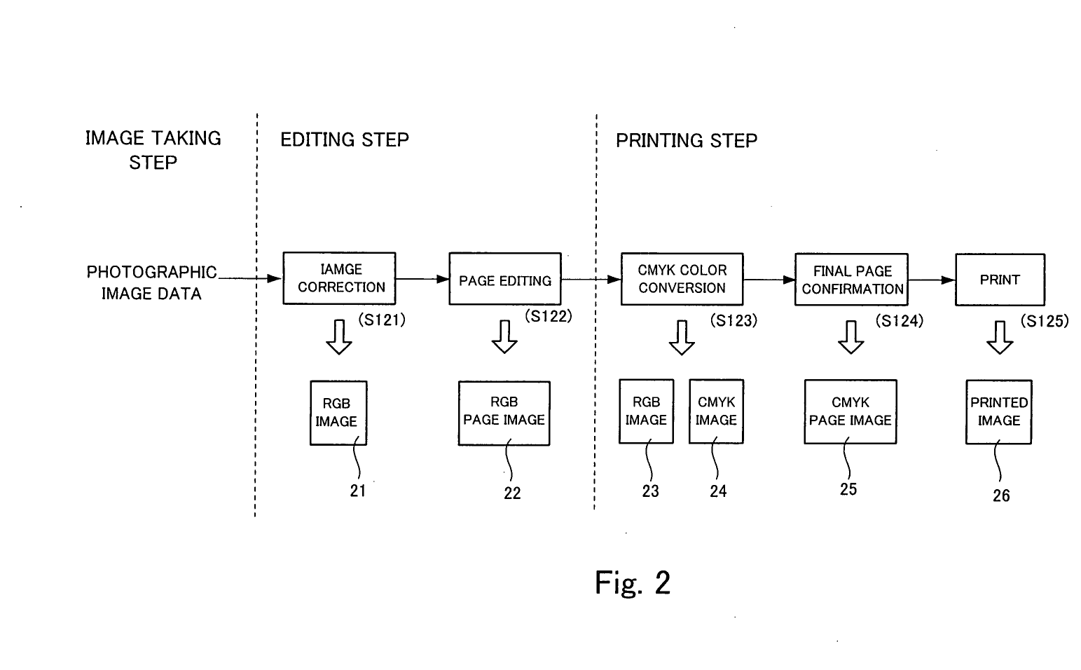

An editor uses a page editing software to edit a page in which the RGB correction image is arranged. At that time, the page data generating section 516 generates RGB page data representative of the page edited by the editor, into which the evaluation incorporation data transmitted from the evaluation incorporation data generating section 514 is incorporated (step S16 in FIG. 8). The thus generated RGB page data is fed to the color printer 2 shown in FIG. 1 so as to print out an RGB page image represented by the RGB page data.

The editor confirms a design of the page through the RGB page image thus printed out. The RGB page data, which is subjected to the editor's confirmation in design, is transmitted via the network to the data obtaining section 521 of the color conversion apparatus 40.

The explanation of the processing in the editing step shown in FIG. 8 is terminated with the above-mentioned description, and next there will be explained a series of processing to be carried out in the color conversion apparatus 40 using the flowchart of FIG. 9.

The RGB page data transmitted from the editing apparatus 30 is obtained by the data obtaining section 521 in FIG. 7 (step S21 in FIG. 9). The thus obtained RGB page data is transmitted to the image processing section 523.

The color conversion apparatus 40 prepares an evaluation output screen that is provided with an “evaluation print button” for printing out an evaluation represented by evaluation data, and an “evaluation display button” for displaying an evaluation on the display screen 32a. When a printing operator instructs an output way of an evaluation in accordance with the evaluation output screen, the evaluation output section 522 outputs an evaluation represented by the evaluation data of the evaluation incorporation data incorporated into the RGB page data in accordance with the designated output way of the evaluation (step S22 in FIG. 9). Here, it is assumed that an editor performs an instruction that an evaluation is displayed on the display screen 32a.

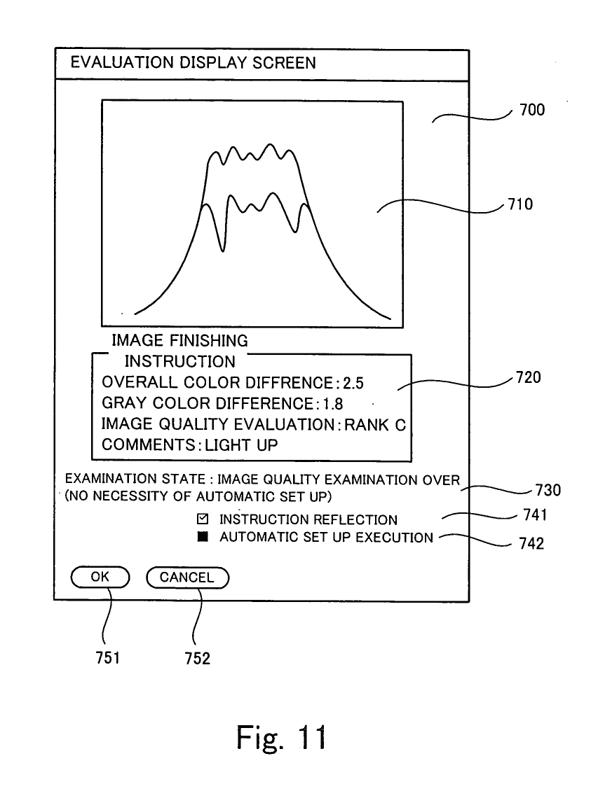

FIG. 11 is a view showing an example of a screen in which an evaluation is displayed.

On an evaluation display screen 700, there are displayed an RGB correction image 710 represented by the corrected RGB data, instruction items 720 representative of an instruction from an editor, of the evaluations represented by the evaluation data, an image quality examination state 730 of any one of “image examination over”, “image examination pending”, and “photographic original”, an instruction reflecting button 741 for instructing whether an instruction of the instruction items 720 is reflected onto the image processing, an automatic set up button 742 for instructing whether an automatic set up (an automatic color correction processing) for automatically correcting a color of the RGB correction image is carried out. An OK button 751 for entering the instruction content, and a cancel button 752 for canceling the instruction content. In the event that the image quality examination state 730 is concerned with the “image examination over”, an editor has already confirmed that the color of the RGB correction image is nice to look at, and there is no need of the color correction processing. Thus, the automatic set up button 742 is masked.

For example, in the event that the image quality examination state 730 is concerned with the “image examination pending”, and the “photographic original” (step S23 in FIG. 9: No), there is a possibility that the color of the RGB correction image is different from the color which an editor desires, and thus it is indicated that there is a need of the color correction processing for the corrected RGB data. In the event that it is desired that the RGB correction image, to which the color correction processing is not applied, is printed out, a printing operator removes a check of the automatic set up button 742 (step S24 in FIG. 9: No) to instruct the omission of the automatic set up. Usually, the printing operator checks the automatic set up button 742 (step S24 in FIG. 9: Yes) to instruct the execution of the automatic set up.

When the printing operator instructs the execution of the automatic set up, the image processing section 523 of the color conversion apparatus 40 shown in FIG. 7 applies to the corrected RGB data of the evaluation incorporation data incorporated in the RGB page data a predetermined image processing for correcting a color of the RGB correction image represented by the corrected RGB data to a color be nice to look at. The automatic set up is the conventional processing, and thus the detailed explanation will be omitted.

When an editor checks the instruction reflecting button 741 (step S26 in FIG. 9), the image processing section 523 of the color conversion apparatus 40 shown in FIG. 7 applies to the corrected RGB data of the evaluation incorporation data incorporated in the RGB page data an image processing according to the instruction items 720 representative of an instruction from an editor, as shown in FIG. 11. For example, in the event that the comment of the instruction items 720 is concerned with “light up”, the tone correction processing is applied so that the intermediate density portion becomes light up. In the event that the comment of the instruction items 720 is concerned with “scatter catch light”, the image processing is applied in such a manner that the tone of the high light side is controlled so as to be slightly lighter than the standard. In the event that the comment of the instruction items 720 is concerned with “be soft”, there is applied the sharpness processing in which emphasis intensity is set up on the weak side. In the event that the comment of the instruction items 720 is concerned with “with variation”, there is applied the sharpness processing in which emphasis intensity is set up on the intensive side. In addition, there is performed the image processing in which for example, “average color difference from the target” is used so that the color difference becomes small.

In this manner, according to the color conversion apparatus 40 of the present embodiment, it is possible to automatically perform the image processing capable of satisfying an editor's wishes, even if a printing operator has no full knowledge as to the image processing.

Further, for example, in the event that the image quality examination state 730 is concerned with the “image examination over” (step S23 in FIG. 9: Yes), it is indicated that a color of the RGB correction image is nice to look at, and thus there is no need of the color correction processing for the corrected RGB data. Thus, no automatic set up is carried out, and the process goes to the image processing according to the instruction from the editor (step S26) omitting the step S24 and the step S25. In this manner, in the event that the color of the RGB correction image represented by the corrected RGB data is a preferable color already, it is possible to omit the automatic set up.

The corrected CMYK data, which is created in such a manner that the color conversion processing is applied to the corrected RGB data, is fed to the on-demand-printing machine 3 shown in FIG. 3 to print out the CMYK correction image represented by the corrected CMYK data.

When an editor confirms a color of the CMYK correction image, the image processing section 523 of the color conversion apparatus 40 shown in FIG. 7 replaces the corrected CMYK data by the corrected RGB data of the RGB page data to generate a CMYK format of CMYK page data. The thus generated CMYK page data is fed to the printing machine 4 to print out a page represented by the CMYK page data (step S28 in FIG. 9).

Thus, the editing apparatus 30 receives an evaluation of a color of an image represented by image data, and generates evaluation incorporation data in association of the image data with the evaluation data representative of the evaluation. And the color conversion apparatus 40 performs a color conversion processing in accordance with the evaluation represented by the evaluation data of the evaluation incorporation data. This feature makes it possible to surely convey the editor's wishes to an printing operator so that the image processing is readily carried out in compliance with the wishes of the editor.

According to the above-mentioned embodiments, as a storage medium for storing an image processing program, there is used a CD-ROM by way of example. However, the storage medium for storing the image processing program is not restricted to the CD-ROM, and any one is acceptable, as the storage medium, for example, MO, FD and a magnetic tape. Further, it is acceptable that the image processing program is directly supplied via a communication network to a computer, without passing through the storage medium.

Further, according to the above-mentioned embodiments, the editing apparatus 30 is connected via the communication network with the color conversion apparatus 40 so that the evaluation incorporation data is transferred via the communication network. In the evaluation output system of the present invention, however, it is acceptable that the evaluation incorporation data, which is generated in the evaluation incorporation data generating section, is recorded in a recording medium such as a CD-ROM, and the data set obtaining section obtains the evaluation incorporation data recorded on the recording medium.

Furthermore, according to the above-mentioned embodiments, there is generated the evaluation incorporation data into which evaluation data is incorporated into the image data. However, it is acceptable that the data set generation section referred to in the present invention is to provide an association between image data and evaluation data, for example, in such a way that an evaluation image data set of the image data and the evaluation data is saved in the same holder.

Still furthermore, according to the above-mentioned embodiments, there is explained an example in which it is indicated to a printing operator whether the automatic set up is executed, and whether an editor's instruction is reflected. However, according to the image processing apparatus of the present invention, it is acceptable to apply the image processing to the image data in accordance with the evaluation represented by the evaluation data, without instructions from a printing operator.

As mentioned above, according to the present invention, it is possible to provide an image processing apparatus capable of surely conveying information for generating an image of a preferable color to the subsequent step, and also capable of easily obtaining an image in which a requirement in the preceding step is reflected, an image processing system, and an image processing program storage medium storing an image processing program, when executed in a computer, which causes the computer to operate as the image processing apparatus.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image processing apparatus comprising:
a data set obtaining section that obtains an evaluation image data set in which image data representative of an image is associated with evaluation data representative of an evaluation as to a color of the image represented by the image data; and
an image processing section that applies an image processing according to an evaluation represented by the evaluation data of the evaluation image data set to the image data of the evaluation image data set obtained by the data set obtaining section.

2. An image processing apparatus according to claim 1, wherein the evaluation image data set is one in which the image data representative of the image is associated with evaluation data representative of an evaluation as to whether a color of the image represented by the image data is a color close to a desired color, and
the image processing section that omits a predetermined image processing for bringing the color of the image close to the desired color or applies the predetermined image processing to the image data of the evaluation image data set in accordance with situations whether the evaluation represented by the evaluation data of the evaluation image data set is concerned with an evaluation that the color of the image is close to the desired color.

3. An image processing apparatus according to claim 1, wherein the evaluation image data set is one in which the image data representative of the image is associated with evaluation data representative of a difference between the color of the image represented by the image data and a desired color, and
the image processing section that applies image processing for correcting a color of an image to the image data of the evaluation image data set in accordance with a difference represented by the evaluation data of the evaluation image data set.

4. An image processing system comprising:
an image obtaining section that obtains image data representative of an image;
an evaluation receiving section that receives an input of an evaluation as to a color of the image represented by the image data obtained by the image obtaining section;
a data set generation section that generates an evaluation image data set in such a way that the image data obtained by the image obtaining section is associated with evaluation data representative of the evaluation received by the evaluation receiving section;
a data set obtaining section that obtains the evaluation image data set; and
an image processing section that applies an image processing according to an evaluation represented by the evaluation data of the evaluation image data set to the image data of the evaluation image data set obtained by the data set obtaining section.

5. An image processing program storage medium storing an image processing program which causes a computer to operate as an image processing apparatus, when the data generating program is executed in the computer, the image processing apparatus comprising:
a data set obtaining section that obtains an evaluation image data set in which image data representative of an image is associated with evaluation data representative of an evaluation as to a color of the image represented by the image data; and
an image processing section that applies an image processing according to an evaluation represented by the evaluation data of the evaluation image data set to the image data of the evaluation image data set obtained by the data set obtaining section.
